(19) United States
(12) Patent Application Publication
(10) Pub. No.: US 2011/0058671 A1
(43) Pub. Date: Mar. 10, 2011

(54) SECURE PROTOCOL TERMINAL ADAPTER

(75) Inventors: Keiron C. Tomasso, Sewell, NJ (US); Nicholas E. Podolak, Somerdale, NJ (US)

(73) Assignee: INFORMATION ASSURANCE SPECIALISTS, INC., Turnersville, NJ (US)

(21) Appl. No.: 12/873,885

(22) Filed: Sep. 1, 2010

Related U.S. Application Data
(60) Provisional application No. 61/240,516, filed on Sep. 8, 2009.

(51) Int. Cl. H04L 12/66; H04K 1/00

(52) U.S. Cl. 380/255; 370/352

(57) ABSTRACT

A system and method for a terminal adapter including a telephony station interface, a data communications interface, and a processing unit. The processing unit is configured to establish a first connection over the data communications interface and a second connection over the telephony station interface. The processing unit is configured to communicate secure information between the first connection and the second connection. The processing unit includes a V.150 internetworking function and/or an Assured Services Session Initiation Protocol (AS-SIP) stack.

### CROSS REFERENCE TO RELATED APPLICATION

This application claims the benefit of U.S. provisional application No. 61/240,516 filed Sep. 8, 2009, which is incorporated by reference as if fully set forth.

### FIELD OF INVENTION

This invention relates to the field of telephony-based communication systems.

### BACKGROUND

Voice communications networks may include two major networking technologies, circuit switched technology and Internet Protocol (IP) technology. Circuit switched networks use switches to establish a dedicated path, or circuit, for voice or data to be communicated. IP networks use packets of information that are individually addressed and routed to communicate data. That data may represent a secure voice call, for example.

In secure voice/data communications, a secure telephone, such as a Secure Terminal Equipment (STE) for example, may plug into a standard telephone wall jack and communicate either in an unencrypted or an encrypted (secure) mode via the circuit switched network with other devices on the circuit switched network. Because the STE uses circuit switching technology, it cannot directly communicate with devices on IP networks.

A gateway interconnects the circuit switched network and the IP network for purposes of secure communication. To use a gateway, however, the STE must connect to the gateway via the circuit switched network.

### SUMMARY

The secure protocol terminal adapter, disclosed herein, enables telephony-based, circuit switched endpoints to directly communicate with devices on the IP network. For example, a communication system may include an analog secure telephony terminal, a remote secure telephony terminal configured to communicate with an Internet Protocol network, and a terminal adapter. The analog secure telephony terminal may be, for example, a Secure Terminal Equipment (STE) device, an OMNI, a Sectera Wireline Terminal (SWT), or any other Secure Communications Interoperability Protocol (SCIP) enabled device. The terminal adapter may enable Internet Protocol connectivity for the analog secure telephony terminal. The analog secure telephony terminal may be connected directly to a terminal adapter. The terminal adapter may be configured to interface between the analog secure telephony terminal and the Internet Protocol network such that a secure channel is established between the remote secure terminal and the analog secure telephony terminal.

The terminal adapter may include a telephony station interface (such as a Foreign eXchange Station (FXS) interface, for example), a data communications interface (such as an Ethernet interface, for example), and a processing unit. The processing unit may be configured to establish a first connection (such as an Assured Services Session Initiation Protocol (AS-SIP) connection and/or a V.150 protocol connection, for example) over the data communications interface and a second connection (such as a V-series MODEM connection, for example) over the telephony station interface. The processing unit may be configured to communicate secure information (such as Type 1 encrypted voice and data information, for example) between the first connection and the second connection. The processing unit may include a V-series modem, V.150 stack and/or an AS-SIP stack.

### BRIEF DESCRIPTION OF THE DRAWINGS

FIG. 1 is a block diagram of an example communications network.

FIG. 2 is a block diagram of an example secure voice/data protocol terminal adapter.

FIG. 3 is a flow diagram of an example method of protocol interworking for secure voice/data communication.

FIG. 4 is a sequence diagram of an example method of protocol interworking for secure voice/data communication.

### DETAILED DESCRIPTION

An example secure voice/data protocol terminal adapter may include an analog telephone interface, a first converter stage, a second dynamic converter stage, an IP telephony protocol stack, an Ethernet Media Access Controller (MAC), and an interface to the Ethernet network. In operation, the analog telephone interface may receive analog voice signals from an analog telephone or analog data signals from an unencrypted data terminal, encrypted voice terminal, or encrypted data terminal. The first converter stage converts analog signals to digital signals. The second dynamic converter stage provides data compression and formatting dependent upon the type of signals being transmitted and includes an audio or voice CODEC, a MODEM, and a V.150 internetworking function. The analog or voice CODEC compresses and formats unencrypted audio. The MODEM modulates/demodulates unencrypted data, encrypted data, or encrypted voice communications. The V.150 internetworking function compresses and formats unencrypted data, encrypted data, or encrypted voice communications. The IP telephony protocol stack performs call management within the IP telephony infrastructure utilizing protocols such as Assured Service-Session Initiation Protocol (AS-SIP), Session Initiation Protocol (SIP), Real-time Transport Protocol (RTP), and Real-time Control Protocol (RTCP). The Ethernet MAC performs Ethernet interface connection management. The Ethernet network interface connects the device to the Ethernet network and IP telephony infrastructure.

Encrypted analog telephony users commonly utilize the Multilevel Precedence and Preemption (MLPP) capabilities within the analog telephony infrastructure. AS-SIP is implemented within the IP telephony protocol stack and performs MLPP within the IP telephony infrastructure. Unencrypted data, encrypted data, and encrypted voice analog telephony devices utilize modem technology from the International Telecommunication Union—Telecommunication Standardization Sector (ITU-T) V-series of Recommendations. The V.150 Modem Relay Protocol is implemented to support an internetworking function relaying the bi-directional V-series modem protocols over the IP telephony infrastructure in a reliable and bandwidth efficient manner.

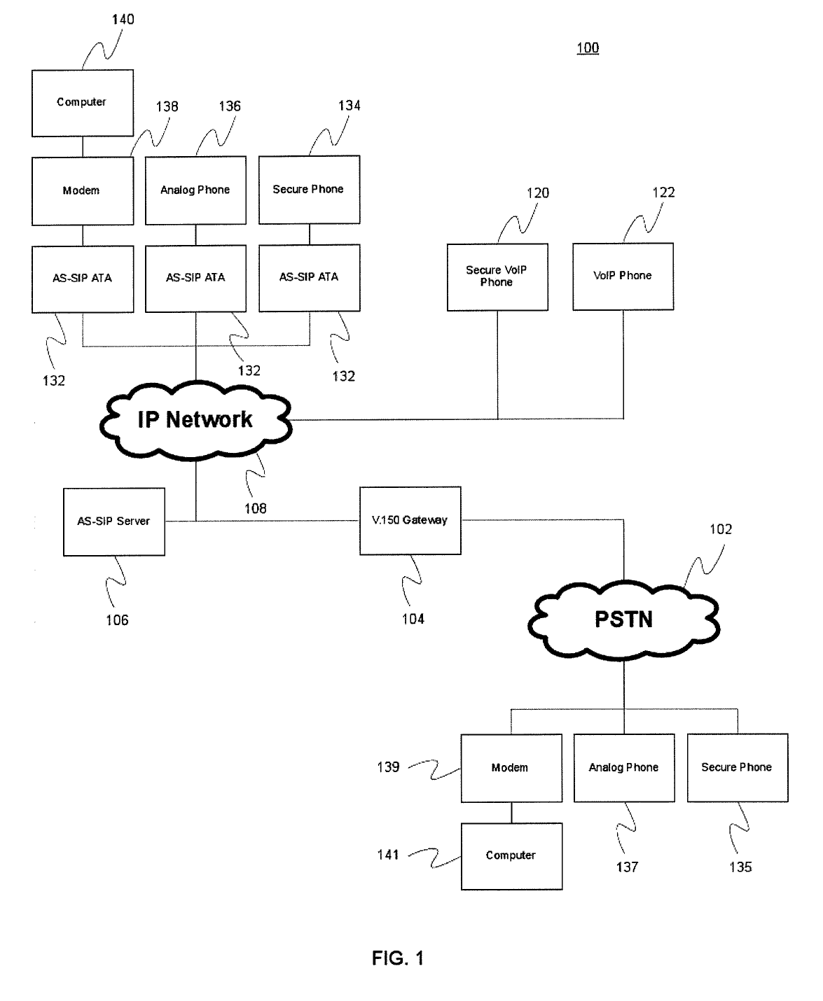

FIG. 1 is a block diagram of an example communications network 100. As illustrated in FIG. 1, the communications network may include an IP network 110 and a circuit switched network, e.g. the public switched telephone network (PSTN) 102. Voice over IP (VoIP) devices such as a secure VoIP phone 120 and a VoIP phone 122 may communicate natively via the IP network 110. However, traditional endpoints (such as computer modems 138, analog phones 136, and secure phones 134) may communicate via the IP network 110 either indirectly over the PSTN 102 and a V.150 gateway 104 or directly using a terminal adapter 132, e.g. an AS-SIP Analog Terminal Adapter (ATA).

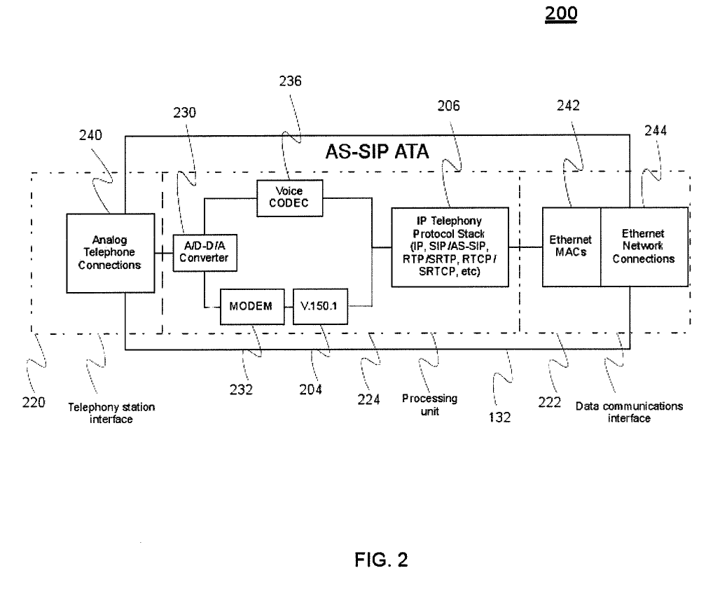

FIG. 2 illustrates an example secure voice/data protocol terminal adapter 200. Such a terminal adapter may be used to connect legacy devices directly to an IP network 110, as illustrated in FIG. 1. The terminal adapter may include telephony station interface 220, a data communications interface 222, and a processing unit 224. The telephony station interface 220 may include an analog telephone connection 240. The data communications interface 222 may include an Ethernet MAC 242 and/or Ethernet network connection 244. The processing unit 224 may include an analog/digital-digital/analog (A/D-D/A) converter 230, a CODEC 236, a MODEM 232, a V.150 internetworking function 204, and/or an IP telephony protocol stack 206. The elements and arrangement of the elements of the adapter and processing unit are illustrative and other elements or arrangements may be used.

The analog telephone interface may include one or more traditional RJ-11/RJ-14/RJ-25 6 position 2, 4, or 6 conductor sockets or jacks. This is the socket or jack found on traditional analog telephone handsets and analog telephone wall jacks. This connector type allows the adapter to interface with a variety of analog telephone equipment including but not limited to telephones, modems, secure telephone terminals, and fax machines. The analog telephone interface carries analog audio to and from the adapter that may be in the form of voice, modulated data or fax information, or dial/notification tones. For example, the analog telephone interface may provide what is referred to in telephony infrastructures as a Foreign eXchange Station (FXS) interface. For example, the analog telephone interface provides voltage to the connected analog telephone equipment as well as a dial tone and analog audio. The analog interface receives any analog audio sent from the attached analog telephone equipment.

The analog telephone connection 240 may be connected to an A/D-D/A converter 230. The A/D-D/A converter 230 provides analog to digital and the reverse digital to analog conversion. The A/D-D/A converter 230 may be implemented within an Applications-Specific Integrated Circuit (ASIC) or a mixed signals System on a Chip (SoC) processor, for example. The A/D-D/A converter 230 may be coupled with the analog telephone interface such that the converter can digitize incoming audio from the analog telephone interface and pass the digitized audio on to either the CODEC 236 or MODEM 232 functions. The A/D-D/A converter 230 may also be coupled with the CODEC 236 or MODEM 232 functions such that any digitized audio from the CODEC 236 or MODEM 232 may be represented on the analog telephone interface as analog audio.

The CODEC 236 performs compression and decompression of digitized audio signals. The CODEC 236 functionality may be performed by an ASIC or Digital Signal Processor (DSP). The CODEC 236 functionality may perform, but is not limited to, one or more of the following audio compression algorithms: G.711 μ-law, G.711 A-law, G.718, G.719, G.722, G.722.1, G.722.2, G.723, G.723.1, G.726, G.728, G.729, G.729.1, Global System for Mobile Communication (GSM) CODEC, Speex, Vorbis, or Internet Low Bitrate CODEC (iLBC). The type of algorithm may be configured in the adapter. The adapter may also negotiate with a communicating party which compression algorithm should be used within the CODEC 236. Configuration and/or negotiation of the compression algorithm may be accomplished by the IP telephony protocol stack 206.

The CODEC 236 receives uncompressed digital audio signals from the A/D-D/A converter 230, compresses the signals using the chosen algorithm, and delivers the compressed digitized audio to the IP telephony stack 206. In the reverse direction, the CODEC 236 receives compressed digitized audio from the IP telephony stack 206, decompresses the compressed digitized audio using the chosen algorithm, and delivers the decompressed digitized audio to the A/D-D/A converter 230.

The MODEM 232 performs the modulation and demodulation functionality as described in the ITU-T V-series Recommendations on data communications over the telephone network. The MODEM 232 functionality can be performed within an ASIC, DSP, and/or general-purpose processor. The MODEM 232 may perform, but is not limited to, one or more of the following V-series ITU-T Recommendations on data communications over the telephone network: V.8, V.21, V.22, V.22bis, V.23, V.24, V.27ter, V.28, V.29, V.32, V.32bis, V.33, V.34, V.34bis, V.41, V.42, V.42bis, V.44, V.90, and/or V.92. The MODEM 232 is used to encode and decode data that is passed between the invention and a far end modem device performing encoding and decoding that is connected to the analog telephone interface.

The MODEM 232 receives uncompressed digital audio signals which carry modulated or encoded data from the far end modem via the A/D-D/A converter 230, performs one or more features of ITU-T V-series Recommendations to demodulate or decode the data, and then delivers the decoded data to the V.150 internetworking function 204. In the reverse direction the MODEM 232 receives data from the V.150 internetworking function 204, encodes the data for transmission to the far side modem connected to the analog telephone interface using one or more of the ITU-T V-series Recommendations, and then passes the encoded data to the A/D-D/A converter 230.

The V.150 internetworking function 204 performs portions of, but is not limited to, the ITU-T V.150 and V.150.1 Recommendations for Modem-over-IP networks, and their subsequent revisions. The V.150 and V.150.1 Recommendations detail how to establish, negotiate, transition between, maintain, and teardown Modem-over-IP connections. The Recommendations detail the use of IP control mechanisms and protocols as well as IP transport mechanisms and protocols to use to accomplish transparent end-to-end modem communications over an IP infrastructure. The V.150 and V.150.1 Recommendations reference the performance of V-series modulations; within the invention these modulations are performed within the MODEM 232. The V.150 internetworking function 204 can be performed within an ASIC, DSP, and/or general-purpose processor. The V.150 internetworking function 204 receives data from the MODEM 232 and performs the adaptation of the data for transmission over an IP network, the data is then passed to the IP telephony protocol stack 206. In the reverse direction, the V.150 internetworking function 204 receives packetized data from the IP telephony protocol stack 206 and adapts the data for transmission over a V-series modem, the data is then passed to the MODEM 232.

The IP telephony protocol stack 206 performs the call management functionality within the IP telephony infrastructure for the invention. This capability can be performed within a general-purpose processor. The primary function of the IP telephony protocol stack 206 is to perform the AS-SIP call management protocol and a suite of supporting IP telephony protocols that may include, but is not limited to: IP, IPv6, ARP, TCP, UDP, DHCP, HTTP, TFTP, FTP, SFTP, SSH, SMTP, TLS, SSL, H.323, SDP, SIP, SCCP, MGCP, SCTP, RTP, RTCP, SPRT, SRTP, SRTCP, UDP-TL, MIKEY, and ZRTP.

AS-SIP allows the user to perform classic telephony tasks, such as, but not limited to, call placement, but also permits, but is not limited to, the user to performing MLPP. MLPP permits a user to select from a striated higher level of service and, if necessary, preempt network capacity to ensure that the user's call is capable of being established and remaining active.

Responsibilities of the IP telephony protocol stack 206 include, but are not limited to, telephony management tasks such as managing network presence, call setup, call initialization, call preemption, call precedence management, parameter negotiation, parameter exchange, managing call state transitions between voice and data modes, call notifications, call forwarding, and call termination. The IP telephony protocol stack 206 is also responsible for managing device configuration. Device configuration may be accomplished using one of the previously mentioned support protocols such as, but not limited to, HTTP using a configuration web page. Device configuration may alternatively be performed utilizing, but not limited to, an automated mechanism such as configuration file retrieval from a TFTP server that is defined by a DHCP server response.

Call data from the CODEC 236 or V.150 internetworking function 204 may be processed by the IP telephony protocol stack 206 and then passed to the Ethernet MAC 242 as a complete IP packet. In the reverse direction, complete IP packets carrying call data may be delivered to the IP telephony protocol stack 206 from the Ethernet MAC 242 and the encapsulated call data is passed to either the CODEC 236 or V.150 internetworking function 204 depending upon the mode of the call. When the call is in voice mode, call data may be passed to and from the CODEC 236 and when the call is a data or modem relay call, the call data may be passed to and from the V.150 internetworking function 204.

The Ethernet MAC 242 manages the inventions participation in the layer 2 Ethernet network. The capability may be performed in a dedicated ASIC or general-purpose processor. The Ethernet MAC 242 may handle Ethernet datagram delivery and reception between the IP telephony protocol stack 206 and other Ethernet entities present on the Ethernet network segment 244.

The Ethernet interface may consist of one or more traditional RJ-45 8 position 8 conductor sockets or jacks. This is the socket or jack found on traditional 10 BASE T, 100 BASE T and 1000 BASE T Ethernet devices. This connector type allows the invention to interface with a variety of Ethernet equipment including but not limited to hubs, switches, routers, computers, access points, and Ethernet gateway devices. Implementation of the adapter may possess one or more connectors representing one or many Ethernet network connections. The Ethernet network interface carries Ethernet datagrams back and forth between the Ethernet MAC 242 and the Ethernet network segment 244.

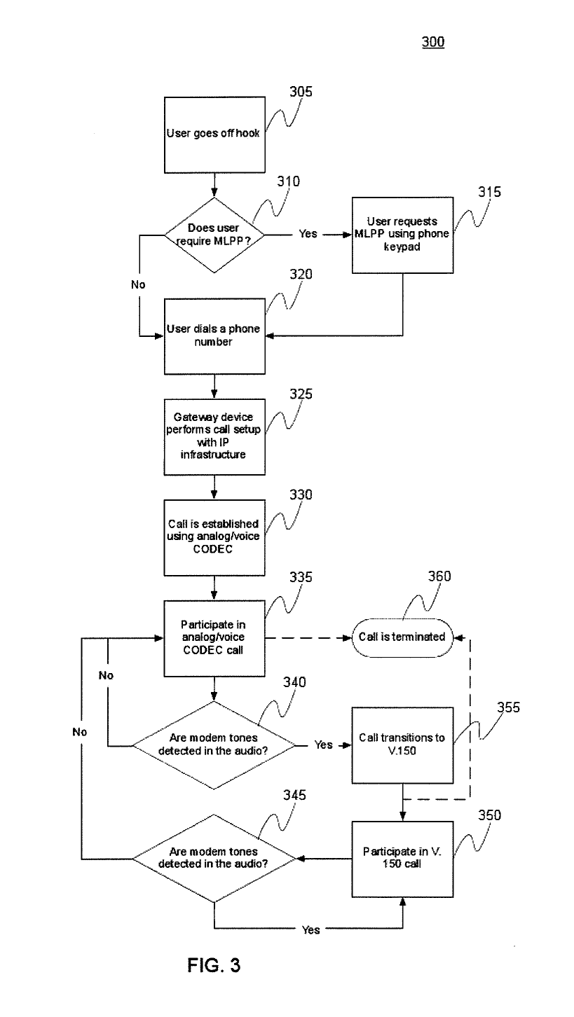

FIG. 3 is a flow diagram of an example method of protocol interworking for secure voice/data communication 300. The process 300 shown in FIG. 3 may be implemented using the terminal adapter disclosed in FIG. 2, for example. The process incorporates MLPP processing once the user goes off hook 305. A call is set up using the analog/voice CODEC 330. If modem tones are detected in the audio 340, then the call may transition to a V.150 interworking call 355. If the modem tones are no longer detected in the audio, the call may transition back to an analog/voice CODEC call 335.

First, a user goes off hook 305. A determination is made whether a user requires MLPP 310. If the user requires MLPP, then the user requests MLPP using the phone keypad 315 and the user dials a phone number 320. If the user does not require MLPP, then the user can immediately dial a phone number 320. A gateway device performs call setup with IP infrastructure 325, a call is established using analog/voice CODEC 330 and participation is enabled in an analog/voice CODEC call 335. If modem tones are detected in the audio 340, the call transitions to V.150 335 and participation is enabled in the V.150 call 350. If no modem tones are detected in the audio 345, the call transitions back to participation in an analog/voice CODEC call 335. The call can be terminated 360 after the call transitions to an analog/voice CODEC call 335, or after the call transitions to a V.150 call 350.

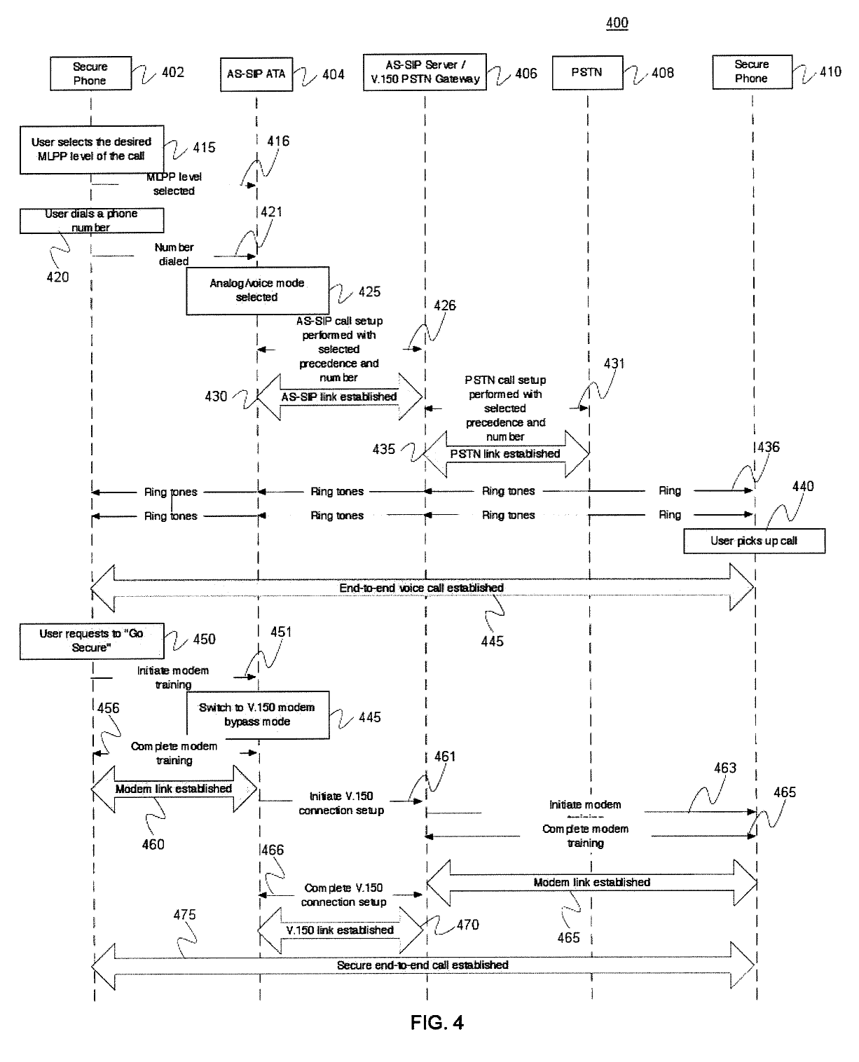

FIG. 4 is a sequence diagram of an example method of protocol interworking for secure voice/data communication 400. In FIG. 4, a secure phone 402 communicates using a terminal adapter 404 via the IP network to a gateway 406 to the PSTN 408 and a traditional analog secure phone 410. A similar call flow may be used to set up a call between the secure phone 402 with terminal adapter 404 and a VoIP secure phone, in which the gateway 406 and PSTN 408 signaling is substituted with the terminal signaling to a VoIP secure phone.

A user selects the desired MLPP level of the call 415 at the secure phone 402. An MLPP level is selected 416 between the secure phone 402 and the terminal adapter 404. The user dials a phone number 420 and after dialing 421, an analog/voice mode is selected 425 at a terminal adapter 404. The terminal adapter 404 and gateway 406 complete AS-SIP call setup with selected precedence and number 426. An AS-SIP link is established 430 between the terminal adapter 404 and the gateway 406. Between the gateway 406 and the PSTN 408, a PSTN call setup is performed with selected precedence and number 431. A PSTN link is established 435 between the gateway 406 and the PSTN 408. Ring tones and rings are exchanged 436 between a secure phone 402, a terminal adapter 404 via the IP network, a gateway 406, the PSTN 408 and a traditional secure phone 410. The user picks up the call 440 at the secure phone 410 and end-to-end voice call is established 445. A user at the secure phone 402 can request to “Go Secure” 450. This initiates modem training 451 and at the terminal adapter 404 a switch to V.150 modem bypass mode occurs 455. This completes modem training 456 between the secure phone 402 and the terminal adapter 404. A modem link is established 460 between the secure phone 402 and the terminal adapter 404. The terminal adapter 404 initiates V.150 connection setup 461 with the gateway 406. The gateway 406 initiates modem training 462 with the secure phone 410 which completes modem training 463 with the gateway 406. A modem link is established 465 between the gateway 406 and the secure phone 410. This completes V.150 connection setup 466 between the gateway 406 and the terminal adapter 404. A V.150 link is established between the gateway 406 and the terminal adapter 404. Finally, a secure end-to-end call is established 475 between the secure phone 402 and the other secure phone 410.

Features and elements are described above in particular combinations, each feature or element can be used alone without the other features and elements or in various combinations with or without other features and elements.

What is claimed is:

1. A system, comprising:
a analog secure telephony terminal;
a remote secure telephony terminal configured to communicate with an Internet Protocol (IP) network; and
a terminal adapter directly connected to the analog secure telephony terminal and configured to interface between the analog secure telephony terminal and the IP network such that a secure channel is established between the remote secure telephony terminal in communication with the IP network and the analog secure telephony terminal.

2. The system of claim 1, wherein the analog secure telephony terminal is a telephony terminal selected from the group consisting of a Secure Terminal Equipment (STE) device, an OMNI, and a Sectera Wireline Terminal.

3. The system of claim 1, wherein the analog secure telephony terminal is a Secure Communications Interoperability Communications (SCIP) enabled device.

4. A terminal adapter that enables Internet Protocol (IP) connectivity for a analog secure telephony terminal, the terminal adapter comprising:
a Foreign eXchange Station (FXS) interface;
an Ethernet interface; and
a processing unit configured to establish a V.150 protocol connection using an Assured Services Session Initiation Protocol (AS-SIP) connection over the Ethernet interface and a V-series modem connection over the FXS interface, wherein the processing unit is configured to communicate encrypted voice and data information using a V.150 protocol between the AS-SIP established connection and the V-series modem.

5. The terminal adapter of claim 4, wherein the processing unit comprises a V-series modem.

6. The terminal adapter of claim 4, wherein the processing unit comprises a V.150 internetworking function.

7. The terminal adapter of claim 4, wherein the processing unit comprises an AS-SIP stack.

8. A device, comprising:
a telephony station interface;
a data communications interface; and
a processing unit configured to establish a first connection over the data communications interface and a second connection over the telephony station interface, wherein the processing unit is configured to communicate secure information between the first connection and the second connection.

9. The device of claim 8, wherein the telephony station interface is a Foreign eXchange Station (FXS) interface.

10. The device of claim 8, wherein the second connection is a V-series modem connection.

11. The device of claim 8, wherein the data communications interface is an Ethernet interface.

12. The device of claim 8, wherein the first connection is an Assured Services Session Initiation Protocol (AS-SIP) established connection that uses a V.150 protocol.

13. The device of claim 8, wherein the secure information is Type 1 encrypted voice information.

14. The device of claim 8, wherein the secure information is Type 1 encrypted data information.

15. A method, comprising:
establishing a first connection over a data communications interface;
establishing a second connection over a telephony station interface; and
communicating secure information between the first connection and the second connection.

16. The method of claim 15, wherein the telephony station interface is a Foreign eXchange Station (FXS) interface.

17. The method of claim 15, wherein the data communications interface is an Ethernet interface.

18. The device of claim 15, wherein the secure information is Type 1 encrypted voice information.

19. The device of claim 15, wherein the secure information is Type 1 encrypted data information.
